(19) United States
(12) Patent Application Publication
(10) Pub. No.: US 2026/0336591 A1
(43) Pub. Date: Oct. 29, 2026

(54) METHOD FOR OPERATING A BRAKE SYSTEM, BRAKE SYSTEM

(71) Applicant: Robert Bosch GmbH, Stuttgart (DE)

(72) Inventors: Michael Janhsen, Stuttgart (DE); Simon Schrade, Baindt (DE)

(21) Appl. No.: 19/629,492

(22) Filed: Mar. 26, 2026

(30) Foreign Application Priority Data
Apr. 29, 2025 (DE) 10 2025 116 366.9

(51) Int. Cl. B60T 13/74

(52) U.S. Cl. CPC B60T 13/746

(57) ABSTRACT

A method for operating a brake system. The brake system includes at least two brake devices which are associated with different wheels of the motor vehicle. Each brake device includes a gear assembly, a parking brake actuator associated with the gear assembly, and a friction partner that can be moved to produce and change a braking force. Each gear assembly includes a rotatable gear which is operatively connected to the friction partner. Each parking brake actuator includes a locking element that can be moved to lock the gear. At least one of the gears is rotated into a rotational position and/or held in a rotational position such that the gear is rotated by a given phase shift relative to the one or another of the gears, and a locking elements is selected and actuated to lock the respective gear as a function of a parking brake request.

### CROSS REFERENCE

The present application claims the benefit under 35 U.S.C. § 119 of Germany Patent Application No. DE 10 2025 116 366.9 filed on Apr. 29, 2025, which is expressly incorporated herein by reference in its entirety.

### FIELD

The present disclosure relates to a method for operating a brake system, in particular of a motor vehicle, wherein the brake system comprises at least two brake devices which are in particular associated with different wheels of the motor vehicle, wherein each one of the brake devices comprises at least one gear assembly, a parking brake actuator associated with the gear assembly, and a friction partner, in particular a brake pad, that can be moved to produce and change a braking force, wherein each one of the gear assemblies comprises at least one rotatable gear which is operatively connected to the friction partner, and wherein each one of the parking brake actuators comprises at least one locking element, in particular a locking pawl, that can be moved to lock the gear.

The present disclosure also relates to such a brake system with a control device that is specifically configured to carry out such a method.

### BACKGROUND INFORMATION

Certain methods and brake systems of the aforementioned type are described in the related art. The described locking mechanism is typically embodied to be form-locking with discrete locking positions. During a parking procedure, the friction partner is moved by means of an actuator into a position that produces a specified force level on an associated friction partner, in particular a brake disc or brake drum. The locking element is then moved to lock the gear, which secures the friction partner in its current position. To end the parking procedure, the locking element is moved away from the gear so that the friction partner can again be moved freely by the actuator.

The use of parking brake actuators in drive trains of motor vehicles is also described in the related art. Germany Patent No. DE 10 2019 205 608 B4, for instance, describes a parking interlock gear with an outer toothing for engaging a locking pawl, i.e. a parking brake actuator with a locking element that can be moved to lock a gear, which, however, is not part of a brake system but of a vehicle transmission.

U.S. Patent No. US 10,315,629 B2 describes a drive system comprising electric motors that are respectively assigned to a left wheel and a right wheel and are each connected in a rotationally fixed manner to a parking gear, and a rotation regulation unit which is configured to engage in the parking gears in order to block the rotation of the wheels. The parking gears can be in a state in which the phases of the respective teeth are shifted relative to one another and initially only one of the parking gears engages. After a minimal movement of the wheel that is not yet blocked, the other parking gear should engage as well.

### SUMMARY

In a method according to an example embodiment of the present disclosure, at least one of the gears is rotated into a rotational position and/or held in a rotational position such that the gear is rotated by a given phase shift relative to the one or another of the gears and at least one of the locking elements is selected and actuated to lock the respective gear as a function of a parking brake request. Certain features of the present disclosure are based on the insight that, when the respective locking element is moved, due to the current rotational position of the respective gear, the brake device may be secured with a parking braking torque that is too low or too high. The gears phase-shifted with respect to one another at least advantageously increases the probability that a correct parking braking torque can be secured in at least one of the brake devices, wherein in particular only the locking element whose associated gear has an advantageous rotational position is moved. A state, in which different parking braking torques or parking braking forces are secured on the brake devices when both locking elements are moved at the same time, is created deliberately. The phase shift of the locking mechanisms can be installed structurally and/or created and controlled via operating strategies. The phase shift ensures that one or more of the locking elements can always engage at the desired parking brake torque, so that a parking procedure can be carried out reliably without generating too little or too much parking braking torque or parking braking force. The method instead allows individual parking brake actuators to contribute little or nothing to the parking procedure because other parking brake actuators are operating in an optimal operating state at the same time. To actively set the phase shift, it is in particular ascertained which of the brake devices, in particular which of the friction partners, should preferentially be worn down in order to achieve the most ideal phase shift. In particular the respective rotational positions that can be set and secured by the respective locking element and the associated braking force are ascertained. The brake devices are preferably actuated in such a way that a state of wear desired for setting the phase shift is achieved, for example to keep the phase shift permanently constant. The brake devices are in particular configured as electromechanical brake devices. The brake devices each comprise service brake actuators that are operatively connected to the respective friction partner via the respective gear assembly, for instance. The service brake actuators in particular each comprise an electric machine. The brake devices are in particular configured according to the by-wire principle, in which there is no mechanical feedthrough to an actuating apparatus that can be actuated by a driver, or which can be mechanically decoupled at least as needed from a corresponding actuating apparatus.

According to a preferred further development of the present disclosure, the gears have the same number of teeth and the phase shift is specified within a tangential distance between two adjacent teeth. Such a specification of the phase shift advantageously ensures that the difference in the braking forces provided by the respective brake devices remains limited.

It is particularly preferred that, to set the phase shift, one of the brake devices is selected and actuated to at least temporarily increase or decrease the braking force relative to the one or another of the brake devices. Such a selection and actuation has the advantage that the respective phase shift is set in a precisely situation-specific manner. The braking force is preferably increased or decreased at least, in particular exclusively, while the motor vehicle is driving, in particular during a braking operation, i.e. while the motor vehicle is moving or is being decelerated. This advantageously generates targeted wear and thus influences the phase shift.

According to a preferred further development of the present disclosure, the locking element whose associated gear is disposed in a rotational position suitable for satisfying the parking brake request is the one that is selected and actuated. Such a selection and actuation of the corresponding locking element advantageously ensures that the brake device best suited to the current situation is used to satisfy the parking brake request.

To ascertain whether the respective gear is disposed in a rotational position suitable for satisfying the parking brake request, it is particularly preferred that a braking force sufficient to satisfy the parking brake request and a braking force achieved by blocking the respective gear in the respective rotational position are ascertained and compared to one another. Such a comparison has the advantage that the most suitable brake device is identified particularly easily and precisely.

According to a preferred further development of the present disclosure, the braking force sufficient to satisfy the parking brake request is ascertained as a function of surroundings information, in particular a road gradient. This taking into account of the surroundings information advantageously ensures that the motor vehicle is held securely at a standstill after the corresponding locking element is actuated. The respective sufficient braking force is in particular increased as the road gradient increases.

It is particularly preferred that, when a plurality of the gears are respectively disposed in a suitable rotational position such that blocking achieves a braking force sufficient to satisfy the parking brake request, the gear with which the braking force achieved by blocking is minimal is the one that is blocked. Blocking the corresponding gear has the advantage that the parking brake request is satisfied with both maximum energy efficiency and minimum mechanical stress on the brake system.

According to a preferred further development of the present disclosure, the brake system comprises more than two, in particular three or four, brake devices which each have a gear assembly comprising a gear and a parking brake actuator which is associated with the gear assembly and comprises a locking element that can be moved to lock the gear, and the locking elements that are selected and actuated are the ones whose associated gears are disposed in a rotational position suitable for jointly fulfilling the parking brake request. Such a selection and actuation of the locking elements advantageously ensures that the parking brake request is reliably satisfied.

It is particularly preferred that, when a plurality of the gears are collectively disposed in a suitable rotational position such that blocking achieves a total braking force sufficient to satisfy the parking brake request, the gears with which the total braking force achieved by blocking is minimal are the ones that are blocked. Blocking the corresponding gears has the advantage that the parking brake request is satisfied with both maximum energy efficiency and minimum mechanical stress on the brake system. Only as many gears are locked or as much parking braking force is provided as is absolutely necessary.

An example brake system having certain features of the present disclosure is in particular configured as a component part of a motor vehicle and comprises at least two brake devices which are in particular associated with different wheels of the motor vehicle, wherein each one of the brake devices comprises at least one gear assembly, a parking brake actuator associated with the gear assembly, and a friction partner, in particular a brake pad, that can be moved to produce and change a braking force, wherein each one of the gear assemblies comprises at least one rotatable gear which is operatively connected to the friction partner, and wherein each one of the parking brake actuators comprises at least one locking element, in particular a locking pawl, that can be moved to lock the gear. It is characterized by a control device that is specifically designed to carry out the method according to the present disclosure. This results in the aforementioned advantages.

Further preferred features and combinations of features result from the above-described and from the rest of the disclosure herein. The present disclosure will be explained in more detail in the following with reference to the figures.

### BRIEF DESCRIPTION OF THE DRAWINGS

FIG. 1 shows a motor vehicle comprising a brake system, according to an example embodiment.

FIG. 2 shows a brake device of the brake system, according to an example embodiment.

FIG. 3 shows components of the brake device, according to an example embodiment.

FIG. 4 shows a force/displacement diagram for the brake system.

FIG. 5 shows a method for operating the brake system, according to an example embodiment.

### DETAILED DESCRIPTION OF EXAMPLE EMBODIMENTS

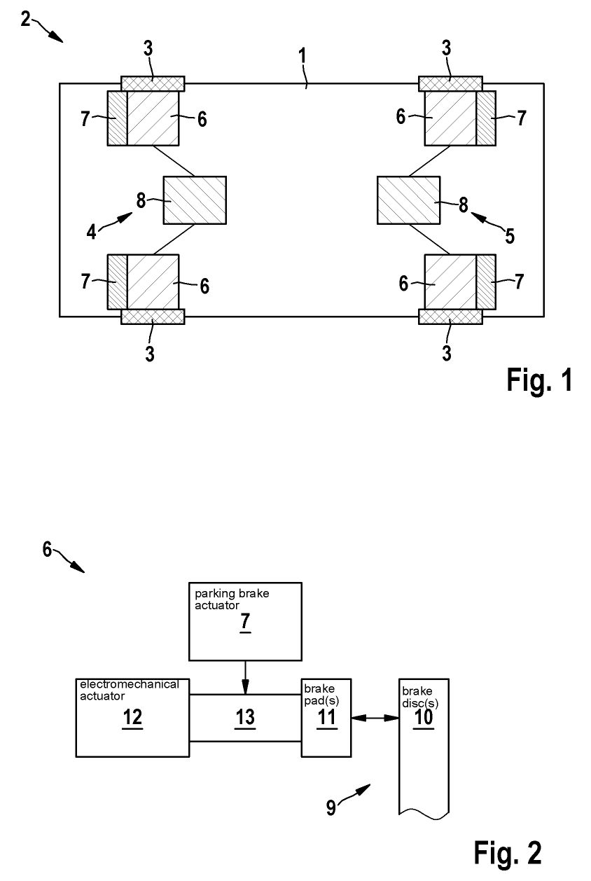

FIG. 1 merely schematically shows a motor vehicle 1. The motor vehicle 1 comprises a brake system 2. The motor vehicle 1 further comprises four wheels 3. Two of the wheels 3 are associated with a first axle 4, for example a front axle, and two other wheels 3 are associated with a second axle 5, for example a rear axle, of the motor vehicle 1.

The brake system 2 comprises at least two, here four, brake devices 6. At least two, here all, of the brake devices 6 comprise a parking brake actuator 7. The brake devices 6 are associated with different wheels 3 of the motor vehicle 1, so that each one of the wheels 3 is associated with exactly one of the brake devices 6 and one of the parking brake actuators 7.

The motor vehicle 1 further comprises two, in particular central, control devices 8. One of the control devices 8 is associated with the first axle 4 and the other of the control devices 8 is associated with the second axle 5. The control devices 8 are in particular part of a vehicle assistance system.

In principle, one control device 8 is sufficient, but the use of two control devices 8 creates an advantageous redundancy, for example if one of the control devices 8 fails. For this purpose, each control device 8 here is associated with two of the brake devices 6 per axle; i.e. two brake devices 6 on different sides of the motor vehicle 1. A cross-wise distribution is possible as well.

The respective brake device 6 is configured to receive a brake request, in particular including a service brake request and/or a parking brake request, from the respective control device 8, in particular by means of the respective control device 8 and/or by means of a control device, not shown here, which is associated with the brake device 6 and has a communication link with the respective control device 8, as a function of the brake request to produce a braking force.

The other control devices 8 are in particular communicatively connected to one another directly via a further communication link, or via a not depicted central control device, in order to coordinate the control of the brake devices 6 and in particular the parking brake actuators 7 as a whole.

FIG. 2 shows one of the brake devices 6 in a detail view. Just as an example, the brake device 6 is configured here as a disc brake, and comprises a brake caliper 9 with at least one brake disc 10 and a friction partner 11 in the form of a brake pad 11.

Preferably, two brake pads 11 are provided, wherein the brake pads 11 are in particular associated with side surfaces of the brake disc 10 that face away from one another. According to another not depicted embodiment example, the brake device 6 is configured as a drum brake.

The brake device 6 further comprises an electromechanical actuator 12, which is configured here as an electric machine, and a gear assembly 13. The actuator 12 is coupled to the brake pad 11 via the gear assembly 13 in order to move the brake pad in the direction of the brake disc 10 and produce and change a braking force or braking torque as indicated by a double arrow. The corresponding parking brake actuator 7 is likewise associated with the gear assembly 13.

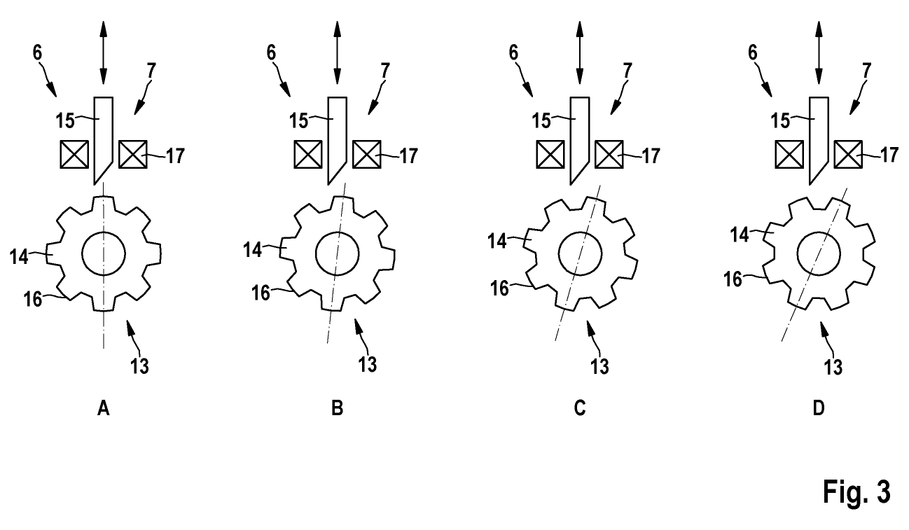

FIG. 3 shows different states of the parking brake actuators 7 and the gear assemblies 13. Each one of the gear assemblies 13 comprises at least one rotatable gear 14 which is operatively connected to the friction partner 11. Each one of the parking brake actuators 7 comprises at least one locking element 15, here a locking pawl 15, that can be moved to lock the gear 14.

The locking element 15 can be moved into a tooth gap between two of the teeth 16 of the gear 14, as indicated by a double arrow, in order to prevent rotation of the gear 14 in a form-locking manner and thus block it. For this purpose, the locking element 15 is operatively connected to a controllable solenoid coil 17 that is used to move the locking element 15. For the sake of clarity, only one of the teeth 16 is provided with reference signs.

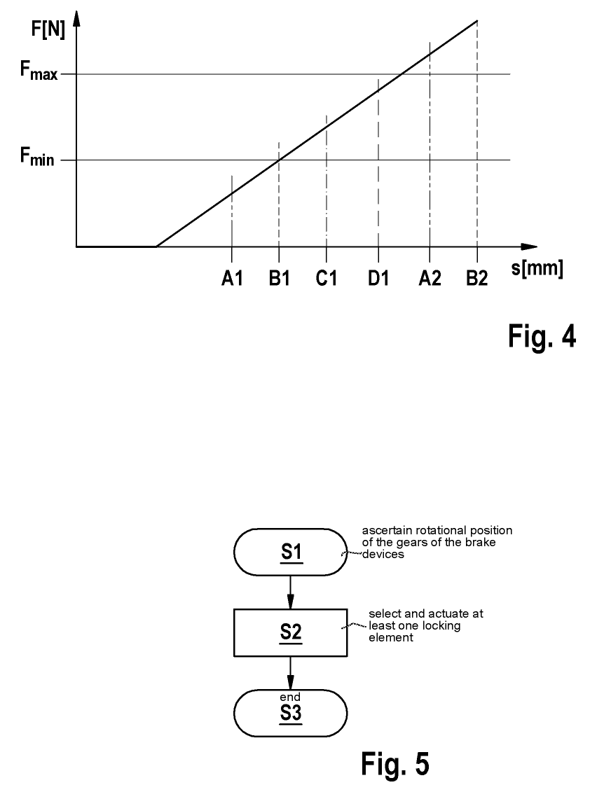

As an example, the figure shows four rotational positions A, B, C, and D of the gears 14 rotated relative to the others by a specified phase shift. In each case, one of the four brake devices 6 of the brake system 2 is moved to a respective different rotational position A, B, C and D, for example, so that, with respect to the teeth 16 of the respective gear 14 closest to the locking element 15, the locking positions of the gear 14 shown in the force/displacement diagram of FIG. 4 which correspond to a respective parking braking force are possible.

The locking position A1 is enabled when the gear 14 is in the rotational position A with a corresponding displacement of the locking element 15, the locking position B1 is enabled when the gear 14 is in the rotational position B, the locking position C1 is enabled when the gear 14 is in the rotational position C, and the locking position D1 is enabled when the gear 14 is in the rotational position D. If the gear 14 were to be rotated a little further from the rotational position A or the rotational position B, the respective next locking position A2 or B2 would be enabled with a corresponding displacement of the locking element 15, and so on.

The locking position resulting from a displacement of the locking element 15 is a function of the geometry of the locking element 15 and the gear 14. A set rotational position corresponds to the locking position resulting from a displacement of the locking element 15, for example. Depending on the geometrical configuration of the locking element 15 and the gear 14, the final locking position can differ at least slightly from the original rotational position. The bevel at the end of the locking element 15, which is shown here as an example, would cause the corresponding tooth 16 to slide off the locking element 15 and the gear 14 to rotate a little further, for instance, so that the rotational position and the locking position are not exactly identical.

An advantageous method for operating the brake system 2 is described in the following with reference to FIG. 5. For this purpose, FIG. 5 shows the method using a flow chart. The method in particular ensures that a parking brake request is always optimally satisfied by the clever selection of the respective parking brake actuators 7 to be used. The method is in particular carried out by means of control devices 8 and/or control devices additionally associated with the respective brake devices 6.

In a step S1, the method begins by ascertaining the rotational position of the gears 14 of at least two, in particular all, of the brake devices 6. At least one of the gears 14 is then rotated into a rotational position and/or held in a rotational position such that the gear 14 is rotated by a given phase shift relative to the one or another of the gears 14. If the gears 14 have the same number of teeth 16, as shown in FIG. 3, the phase shift is preferably specified within a tangential distance between two adjacent teeth 16.

If one of the gears 14 is in the rotational position A shown in FIG. 3, for example, another of the gears 14 is rotated into one of the rotational positions B, C, or D. In particular all of the gears 14 are included in this control, so that one of the gears 14 is always in another of the rotational positions A, B, C, and D as described above. Each rotational position thus occurs once, which overall provides an advantageous maximum selection option for the method.

To set the phase shift, in particular one of the brake devices 6 is selected and actuated to at least temporarily increase or decrease the braking force relative to the one or another of the brake devices 6.

The brake system 2 is also monitored for a parking brake request and, if a parking brake request is detected, the method is continued with a step S2. At least one of the locking elements 15 is then selected and actuated, i.e. moved into the corresponding tooth gap, to lock the respective gear 14 as a function of a parking brake request.

The locking element 15 whose associated gear 14 is disposed in a rotational position suitable for satisfying the parking brake request is preferably the one that is selected and actuated. To ascertain whether the respective gear 14 is disposed in a rotational position suitable for satisfying the parking brake request, a braking force sufficient to satisfy the parking brake request and a braking force achieved by blocking the respective gear 14 in the respective rotational position are in particular ascertained and compared to one another.

The braking force sufficient to satisfy the parking brake request is particularly preferably ascertained as a function of surroundings information, in particular a road gradient.

In FIG. 4, for example, a minimum needed braking force Fₘᵢₙ and a maximum permissible braking force Fₘₐₓ (above which the brake device 6 would be damaged) are shown as lines, and it can be seen that the locking position A1 results in insufficient braking force; i.e. the parking brake request cannot be satisfied in this locking position or at least not with the corresponding brake device 6 alone. Conversely, in the locking position A2, the parking brake request would indeed be satisfied, but the brake device 6 would also be damaged.

All of the locking positions B1, C1 and B1 are suitable for satisfying the parking brake request, because they result in braking forces that lie between the minimum needed braking force Fₘᵢₙ and the maximum permissible braking force Fₘₐₓ. Depending on which of the locking positions can be reached from the respective rotational position, the corresponding brake device 6 can be selected and the corresponding locking element 15 can be actuated to block the gear 14.

To ensure the most efficient use of the brake system 2 when a plurality of the gears 14 are respectively disposed in a suitable rotational position such that blocking achieves a braking force sufficient to satisfy the parking brake request, the gear 14 with which the braking force achieved by blocking is minimal is preferably the one that is blocked. In the present example, provided that the locking position B1 can be reached (and the adjacent locking position B2 is not approached unintentionally), this is the gear 14 in the rotational position B.

Because the brake system 2 here comprises more than two, namely four, brake devices 6 which each have a gear assembly 13 comprising a gear 14 and a parking brake actuator 7 which is associated with the gear assembly 13 and comprises a locking element 15 that can be moved to lock the gear 14, the parking brake request can alternatively be satisfied jointly by a plurality of the locking elements 15.

For this purpose, the locking elements 15 whose associated gears 14 are disposed in a rotational position suitable for jointly satisfying the parking brake request are preferably the ones that are selected and actuated. Similarly to the above-described procedure, in particular when a plurality of the gears 14 are collectively disposed in a suitable rotational position such that blocking achieves a total braking force sufficient to satisfy the parking brake request, the gears 14 with which the total braking force achieved by blocking is minimal are the ones that are blocked. The method ends in each case with a step S3.

What is claimed is:

1. A method for operating a brake system of a motor vehicle, the brake system including at least two brake devices which are associated with different wheels of the motor vehicle, wherein each of the brake devices includes a respective gear assembly, a respective parking brake actuator associated with the respective gear assembly, and a respective friction partner that can be moved to produce and change a braking force, and wherein each of the respective gear assemblies includes a respective rotatable gear which is operatively connected to the respective friction partner, and wherein each of the respective parking brake actuators includes a respective locking element that can be moved to lock the respective gear, the method comprising the following steps:
rotating at least one of the respective gears into a rotational position and/or holding the at least one of the respective gears in a rotational position, such that the at least one of the respective gears is rotated by a given phase shift relative to the at least one of the respective gears or another of the respective gears; and
selecting and actuating at least one of the respective locking elements to lock the respective gear as a function of a parking brake request.

2. The method according to claim 1, wherein the friction partner is a brake pad, and the at least one locking element includes a locking pawl.

3. The method according to claim 1, wherein the respective gears have the same number of teeth and that the phase shift is specified within a tangential distance between two adjacent teeth.

4. The method according to claim 1, wherein, to set the phase shift, one of the brake devices is selected and actuated to at least temporarily increase or decrease the braking force relative to the one of the brake devices or another of the brake devices.

5. The method according to claim 1, wherein the respective locking element whose respective gear is disposed in a rotational position suitable for satisfying the parking brake request is the respective locking element that is selected and actuated.

6. The method according to claim 5, wherein, to ascertain whether the respective gear is disposed in the rotational position suitable for satisfying the parking brake request, a braking force sufficient to satisfy the parking brake request and a braking force achieved by blocking the respective gear in the respective rotational position are ascertained and compared to one another.

7. The method according to claim 6, wherein the braking force sufficient to satisfy the parking brake request is ascertained as a function of surroundings information including a road gradient.

8. The method according to claim 1, wherein, when a plurality of the respective gears are respectively disposed in a suitable rotational position such that blocking achieves a braking force sufficient to satisfy the parking brake request, the respective gear with which the braking force achieved by blocking is minimal is the respective gear that is blocked.

9. The method according to claim 1, wherein the brake system includes more than two brake devices which each have a respective gear assembly including a respective gear and a respective parking brake actuator which is associated with the respective gear assembly and includes a respective locking element that can be moved to lock the respective gear, and the respective locking elements whose respective gears are disposed in a rotational position suitable for jointly satisfying the parking brake request are the respective locking elements that are selected and actuated.

10. The method according to claim 1, wherein, when a plurality of the respective gears are collectively disposed in a suitable rotational position such that blocking achieves a total braking force sufficient to satisfy the parking brake request, the respective gears with which the total braking force achieved by blocking is minimal are the respective gears that are blocked.

11. A brake system of a motor vehicle, comprising:
at least two brake devices which are associated with different wheels of the motor vehicle, wherein each of the brake devices including a respective gear assembly, a respective parking brake actuator associated with the respective gear assembly, and a respective friction partner that can be moved to produce and change a braking force, wherein each of the respective gear assemblies includes a respective rotatable gear which is operatively connected to the friction partner, and wherein each of the respective parking brake actuators includes a respective locking element that can be moved to lock the respective gear; and
a control device configured to operate the brake system, the control device configured to:
rotate at least one of the respective gears into a rotational position and/or hold the at least one of the respective gears in a rotational position, such that the at least one of the respective gears is rotated by a given phase shift relative to the at least one of the respective gears or another of the respective gears; and
select and actuate at least one of the respective locking elements to lock the respective gear as a function of a parking brake request.
